(19) United States
(12) Patent Application Publication
(10) Pub. No.: US 2023/0106674 A1
(43) Pub. Date: Apr. 6, 2023

(54) AN AUTOMATIC LANDING METHOD, SYSTEM, AND STORAGE MEDIUM FOR LASER PROCESSING

(71) Applicant: INNOFOCUS PHOTONICS TECHNOLOGY PTY LTD, Shenzhen, Guangdong (CN)

(72) Inventors: Han LIN, Victoria (AU); Jinchuan ZHENG, Victoria (AU); Baohua JIA, Victoria (AU)

(21) Appl. No.: 17/907,391

(22) PCT Filed: Jul. 1, 2020
(86) PCT No.: PCT/CN2020/099656

§ 371 Date: Sep. 26, 2022

(30) Foreign Application Priority Data
Mar. 27, 2020 (CN) 202010230274.5

(51) Int. Cl. B23K 26/046; B23K 26/70

(52) U.S. Cl. CPC B23K 26/046; B23K 26/702

(57) ABSTRACT

An automatic landing method, system, and storage medium for laser processing. The method includes: adjusting the relative position of the microscope objective and the workpiece to be processed along the direction of the optical axis within a preset travel range; during the adjustment process, collecting images of the workpiece to be processed in real-time and detecting the intensity of reflected light or fluorescence in real-time according to the image; determine the position of the strongest reflected light or the fluorescence initiation position according to the intensity detection data of reflected light or fluorescence. By scanning the intensity of reflected light or fluorescence, the invention achieves the purpose of quickly and accurately adjusting the laser focus to land on the surface to be processed, effectively improving the processing success rate, processing quality, and processing accuracy, and the solution is economical and efficient.

This application claims the priority of the Chinese patent application filed on Mar. 27, 2020, with the application number of 202010230274.5 and the invention titled “an automatic landing method, system, and storage medium for laser processing”, which the entire contents of this application are incorporated by reference.

### TECHNICAL FIELD

The invention relates to the technical field of laser processing, particularly an automatic landing method, system, and storage medium for laser processing.

### TECHNICAL BACKGROUND

Laser nanofabrication, also known as laser 3D nanoprinting technology, has the advantages of simple processing equipment, fast and low-cost fabrication process, and 3D processing capability. It has become one of the most crucial emerging high-precision manufacturing technologies.

Laser 3D nanoprinting technology uses high light intensity in the focal region of a tightly focused laser beam that is usually focused by a microscope objective to the processing position. The laser focus is used to modify material properties to fabricate structures with nanometer precision in different materials (including polymers, glass, metals, new two-dimensional materials, etc.).

Using femtosecond laser 3D nanoprinting technology, structures with different functions can be fabricated, including polymer photonic crystal structures, ultrathin microlenses, miniature optical waveguides, and fiber gratings. Moreover, it has high spatial resolution due to the small affected area and can achieve nanometer positioning accuracy. Therefore, it has attracted extensive attention in micro/nanofabrication requiring ultrahigh precision.

Due to its three-dimensional high precision, in the process of laser nanofabrication, it is particularly critical to control the relative position of the laser focus and the workpiece to be processed to be processed. In general, at the beginning of laser processing, the user needs to land the laser focus on the workpiece to be processed's surface based on the user's experience. At the same time, for different workpiece to be processeds, the user needs to land the laser focus according to different criteria. Therefore, for inexperienced users, this operation of landing the focus on the workpiece to be processed's surface presents a high risk. If the user keeps approaching microscope objective to the workpiece to be processed when landing the focus, the microscope objective may directly hit the workpiece to be processed, damaging the workpiece to be processed and the microscope objective and causing processing failure. Therefore, there is an urgent need for a solution that can automatically land the laser focus on the workpiece to be processed's surface.

### SUMMARY OF THE INVENTION

The purpose of the present invention is to provide an automatic landing method, system, and storage medium for laser processing, to solve the problem that the existing technology cannot automatically land the laser focus on the workpiece to be processed's surface.

For this purpose, the present invention adopts the following technical solutions:

An automatic landing method for laser processing, comprising:

The method adjusts the relative position of the microscope objective and the workpiece to be processed along the optical axis direction within the preset travel range. During the adjustment process, the image of the workpiece to be processed and the laser beam is collected in real-time, and the intensity of the reflected light is detected in real-time according to the image.

According to the intensity detection data of the reflected light, the method determines the position of the strongest reflected light. The position of the strongest reflected light is the relative position of the microscope objective and the workpiece to be processed when the intensity of the reflected light reaches the maximum value.

Optionally, the automatic landing method further includes:

Obtaining a plurality of positions of the strongest reflected light. Each position of strongest reflected light is determined when the laser beam is focused on different designated areas of the workpiece to be processed's surface.

The inclination angle of the workpiece to be processed's surface relative to the microscope objective is calculated according to the multiple positions of the strongest reflected light.

Optionally, the automatic landing method further includes:

Obtaining a plurality of positions of the strongest reflected light. Each position of the strongest reflected light is determined when the laser beam is focused on different designated areas of the workpiece to be processed's surface;

Calculating the average position of the multiple positions of the strongest reflected light;

According to the average position, after adjusting the relative position of the microscope objective and the workpiece to be processed, laser processing is performed.

Optionally, the real-time detection of the intensity of the reflected light according to the image includes:

The grayscale value of the reflected light in the image is calculated first, and then the grayscale value is calculated and converted to obtain the intensity of the reflected light.

An automatic landing method for laser processing, comprising:

Within the preset travel range, the method adjusts the relative position of the microscope objective and the workpiece to be processed along the direction of the optical axis; during the adjustment process, collect the image of the workpiece to be processed in real-time, and detect whether there is fluorescence in real-time according to the image.

According to the fluorescence detection result, determine the fluorescence initiation position. The fluorescence initiation position is the relative position of the microscope objective and the workpiece to be processed when the fluorescence starts to appear.

Optionally, the automatic landing method further includes:

Obtaining a plurality of fluorescence initiation positions. Each fluorescence initiation position is determined when the laser beam is focused to different designated areas of the workpiece to be processed's surface;

According to the plurality of fluorescence originating positions, the inclination angle of the workpiece to be processed's surface relative to the microscope objective is calculated.

Optionally, the automatic landing method further includes:

Obtaining a plurality of fluorescence initiation positions. Each fluorescence initiation position is determined when the laser beam is focused to different designated areas of the workpiece to be processed's surface;

Calculating the average position of the multiple fluorescence initiation positions;

According to the average position, after adjusting the relative position of the microscope objective and the workpiece to be processed, laser processing is performed.

An automatic landing system for laser processing, comprising a microscope objective for focusing a laser beam, which further comprising: an image sensor, a driver, a detector, and a controller;

The image sensor is used to capture the image of the workpiece to be processed and the laser beam in real-time during the position adjustment process;

The detector is configured to detect the intensity of the reflected light in real-time according to the image;

The controller is used to adjust the relative position of the microscope objective and the workpiece to be processed through the driver within a preset travel range along the optical axis direction. It is also used to determine the position of the strongest reflected light according to the detection data of the detector. The position of the strongest reflected light is the relative position of the microscope objective and the workpiece to be processed when the intensity of the reflected light reaches the maximum value.

Optionally, the controller is further configured to obtain a plurality of positions of the strongest reflected light. Each position of the strongest reflected light is determined when the laser beam is focused on different designated areas of the workpiece to be processed's surface. The inclination angle of the workpiece to be processed's surface relative to the microscope objective is calculated by calculating the positions of the strongest reflected light, and/or calculating the average position of the positions of the strongest reflected light. Adjusting the relative position of the microscope objective and the workpiece to be processed according to the average position to perform laser processing.

An automatic landing system for laser processing, comprising a microscope objective for focusing a laser beam; further comprising: an image sensor, a driver, a detector, and a controller;

The image sensor is used to capture the image of the workpiece to be processed and laser beam in real-time during the position adjustment process;

The detector is used for detecting in real-time whether fluorescence is generated according to the image;

The controller is used to adjust the relative position of the microscope objective and the workpiece to be processed through the driver within a preset travel range along the optical axis direction and is also used to determine the fluorescence initiation position according to the fluorescence detection result. The fluorescence initiation position is the relative position of the microscope objective and the workpiece to be processed when the fluorescence starts to appear.

Optionally, the controller is further configured to obtain a plurality of fluorescence initiation positions. Each fluorescence initiation position is determined when the laser beam is focused on different designated areas of the workpiece to be processed's surface. According to the plurality of fluorescence initiation positions, the inclination angle of the workpiece to be processed's surface relative to the microscope objective is obtained, and/or, those positions are also used to calculate the average position of the plurality of fluorescence initiation positions. It adjusts the relative position of the microscope objective and the workpiece to be processed according to the average position.

A storage medium stores a plurality of instructions. A processor loads the instructions to perform the steps in the automatic landing method according to any one of the above.

Compared with the prior art, the embodiments of the present invention have the following beneficial effects:

The embodiment of the present invention determines the relative position of the microscope objective and the workpiece to be processed when the laser focus lands on the surface of the workpiece to be processed by scanning the intensity of the reflected light or fluorescence, thereby realizing the purpose of quickly and accurately landing the laser focus on the surface of the surface, effectively improve the processing yield, quality, and accuracy;

At the same time, since the embodiments of the present invention are mainly implemented in software, the hardware part only needs to use low-cost image sensors. No major changes are required to the existing laser processing system, so the entire solution is cost-effective.

### DESCRIPTION OF DRAWINGS

In order to explain the embodiments of the present invention or the technical solutions in the prior art more clearly, the following briefly introduces the accompanying drawings that need to be used in the description of the embodiments or the prior art. Obviously, the accompanying drawings in the following description are only some embodiments of the present invention. For those of ordinary skill in the technical field, other drawings can also be obtained based on these drawings without any creative effort.

FIG. 1 is a flow chart of an automatic landing method provided in Embodiment 1 of the present invention;

FIG. 2 to FIG. 4 are schematic diagrams of the implementation of automatic landing provided by Embodiment 1 of the present invention;

FIG. 5 is a flowchart of an automatic landing method provided in Embodiment 2 of the present invention;

FIG. 6 to FIG. 7 are schematic diagrams of the implementation of automatic landing by Embodiment 2 of the present invention;

FIG. 8 is a curve of the intensity of reflected light versus the z position based on the reflected light intensity scanning method;

FIG. 9 shows a fluorescence intensity curve versus the z position based on the fluorescence scanning method.

### DETAILED IMPLEMENTATION METHODS

In order to make those skilled people in the field better understand the embodiments of the present invention, the following will clearly and completely describe the technical solutions in the embodiments of the present invention with reference to the accompanying drawings in the embodiments of the present invention. Obviously, the described implementations of the examples are only a part of the embodiments of the present invention, but not all of the embodiments. Based on the examples in the embodiments of the present invention, all other embodiments obtained by persons of ordinary skill in the field without creative work shall fall within the protection scope of the embodiments of the present invention.

The terms “comprising” and “having” in the description and claims of the embodiments of the present invention and the above-mentioned drawings and any variations thereof are intended to cover non-exclusive inclusion, for example, a process comprising a series of steps or units, a method, system, product or device is not necessarily limited to those steps or units expressly listed, but may include other steps or units not expressly listed or inherent to the process, method, product or device.

The embodiments of the present invention can be applied to a laser processing system, which mainly includes a laser and a microscope objective. Among them, the laser is used to form a laser beam. The microscope objective is used to focus the laser beam, and the laser beam is focused on the workpiece to be processed's surface.

In order to accurately focus the laser beam on the processing surface and to use the high light intensity at the laser focus to achieve efficient and accurate laser processing on the workpiece to be processed, the present invention provides a solution for automatically landing the laser focus on the workpiece to be processed's surface, according to the reflected light intensity of the laser or the fluorescence excited by the laser. It can quickly and accurately adjust the position of the laser focus to land on the workpiece to be processed's surface, thereby effectively ensuring processing accuracy and improving processing quality and yield.

### Embodiment 1

Usually, during laser nanofabrication, a dielectric layer is formed between the microscope objective and the workpiece to be processed. The microscope objective focuses the laser beam on the workpiece to be processed's surface through the dielectric layer.

Specifically, the medium layer can be selected from air, oil matched with the required refractive index difference or other types of materials. In practical applications, if the microscope objective is an air immersion objective, the medium layer is air; if the microscope objective is an oil immersion objective, the medium layer is refractive index matching oil.

Since the dielectric layer and the workpiece to be processed have a certain refractive index difference, the incident laser will be reflected at the interface between the dielectric layer and the workpiece to be processed (ie, the surface to be processed). The intensity of the reflected light depends on the difference in the refractive indice of dielectric layer and the workpiece to be processed.

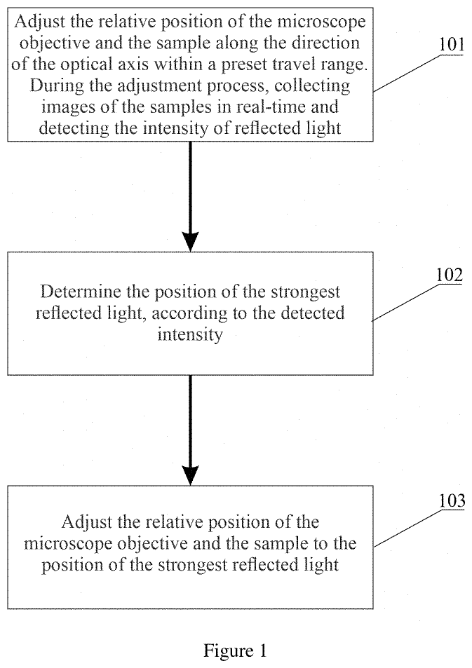

Referring to FIG. 1, an embodiment of the present invention provides an automatic landing method, which is realized based on the intensity of reflected light, and includes the steps:

Step 101: Adjust the relative position of the microscope objective and the workpiece to be processed along the optical axis within a preset travel range. During the adjustment process, collect images of the workpiece to be processed and the laser beam in real-time and detect the intensity of reflected light in real-time according to the images.

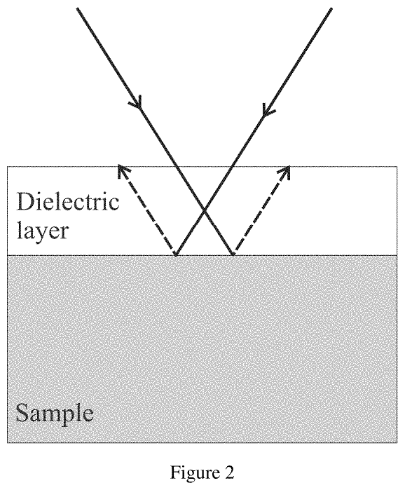

In this step, with the adjustment of the relative position of the microscope objective and the workpiece to be processed, the relative position of the laser focus and the workpiece to be processed's surface will change accordingly. During the adjustment process, please refer to FIG. 2, the relative positions of the laser focus and the surface of the workpiece to be processed have the following three situations: (1) the laser focus is located above the workpiece to be processed's surface, that is, the position of the laser focus is too shallow; (2) The laser focus is located on the workpiece to be processed's surface; (3) The laser focus is located below the workpiece to be processed's surface, that is, the position of the laser focus is too deep.

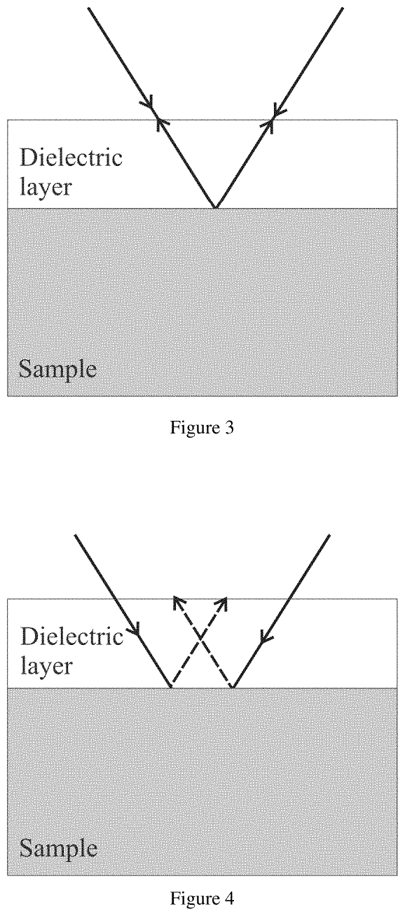

During the adjustment of the relative position of the laser focus and the workpiece to be processed's surface, the intensity of the reflected light also changes accordingly. Please refer to FIG. 2 to FIG. 4. Comparing the three cases, when the laser focus moves to the surface, the intensity of the reflected light reaches the maximum. When the laser focus starts to move up or down from the surface, the intensity of the reflected light will gradually decrease. Therefore, when the intensity of the reflected light reaches the maximum, it can be determined that the laser focus lands on the surface.

The intensity of the reflected light can be calculated as follows: first calculate the grayscale value of the reflected light in the image, and then convert the grayscale value to calculate the intensity of the reflected light in the laser beam area.

Step 102: Determine the position of the strongest reflected light according to the intensity detection data of the reflected light.

The position of the strongest reflected light refers to the relative position of the microscope objective and the workpiece to be processed when the intensity of the reflected light reaches the maximum.

Step 103: Adjust the relative position of the microscope objective and the workpiece to be processed to the position where the reflected light is the strongest so that the focus of the laser can be landed on the workpiece to be processed's surface.

In the above method, the adjustment speed is not specified in performing the position adjustment within the preset travel range. In actual operation, the user can align the optical axis of the laser beam with different areas on the workpiece to be processed's surface, and repeat steps 101 to 102 to obtain the position of the strongest reflected light corresponding to each area. Then these positions of the strongest reflected light can be processed to confirm the most ideal landing position. The inclination angle of the workpiece to be processed's surface relative to the microscope objective can be calculated and corrected according to these positions of strongest reflected light.

To sum up, in this embodiment, the reflected light of the laser is obtained based on the refractive index difference between the medium layer and the workpiece to be processed, which introduces reflection. Then the position of the strongest reflected light is identified according to the intensity of the reflected light. The purpose of quickly and accurately adjusting the laser focus to land on the workpiece to be processed's surface is achieved. Therefore, this embodiment applies to any kind of workpiece to be processed and is especially suitable for workpiece to be processeds, whose surfaces have apparent reflection, such as two-dimensional material surfaces or metal-coated surfaces.

### Embodiment 2

The embodiment of the present invention provides another automatic landing method, which is implemented based on fluorescence scanning.

It should be noted that the dielectric layer and the workpiece to be processed need to meet the following requirements: the dielectric layer cannot generate fluorescence when it is irradiated by laser; the workpiece to be processed can be excited to generate fluorescence when the laser is focused into the workpiece to be processed. Otherwise, it cannot generate fluorescence. Therefore, compared with the reflected laser light intensity in the first embodiment, the strongest laser light intensity must be set in the second embodiment to ensure enough fluorescence can be excited for detection.

The medium layer is specifically air, oil, or other types of materials. In practical applications, if the microscope objective is an air immersion objective, the medium layer is air; if the microscope objective is an oil objective, the medium layer is oil.

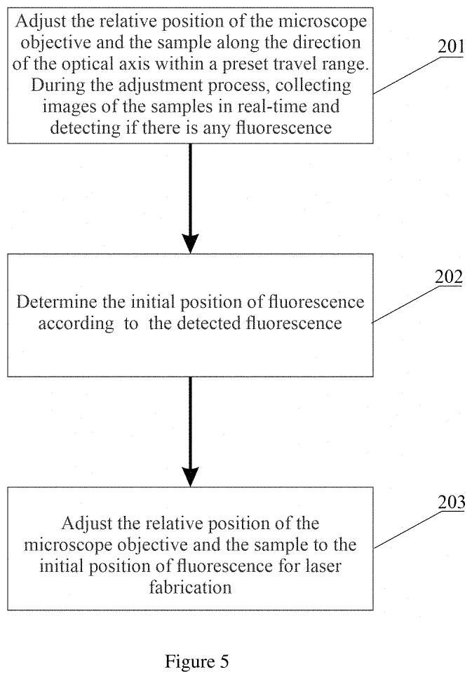

Referring to FIG. 5, the automatic landing method according to the embodiment of the present invention includes:

Step 201: Adjust the relative position of the microscope objective and the workpiece to be processed along the optical axis direction within a preset travel range; during the adjustment process, collect images of the workpiece to be processed in real-time and detect whether fluorescence occurs according to the images.

In this step, as the relative position of the microscope objective and the workpiece to be processed is adjusted, the relative position of the laser focus and the workpiece to be processed will change accordingly. During the adjustment process, please refer to FIG. 4. The relative position of the laser focus and the workpiece to be processed includes the following two situations: (1) the laser focus does not reach the workpiece to be processed; (2) the laser focus reaches the inside of the workpiece to be processed.

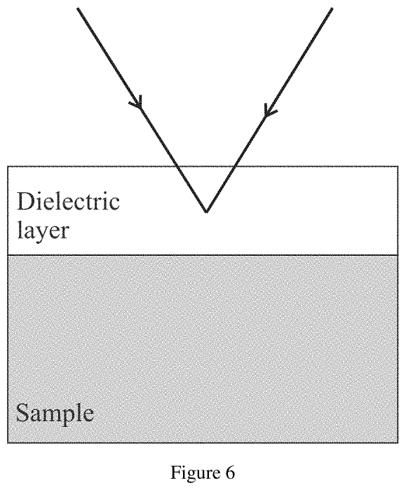

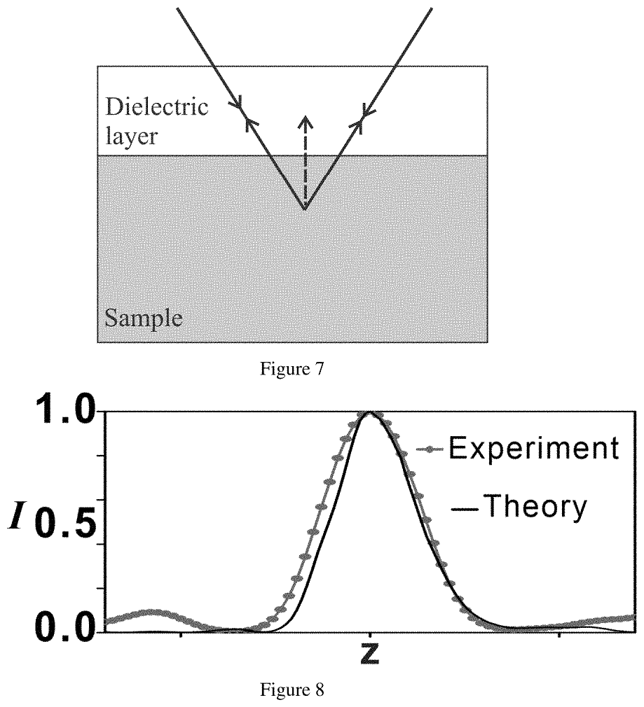

The fluorescence will change when adjusting the relative position of the laser focus and the workpiece to be processed. Comparing the two cases, please refer to FIG. 6 to FIG. 7. When the laser focus does not reach the workpiece to be processed, fluorescence does not appear, and when the laser reaches the inside of the workpiece to be processed, fluorescence occurs. Therefore, when the fluorescence begins to appear, it can be determined that the laser focus reaches the workpiece to be processed's surface.

Step 202: Determine the fluorescence initiation position according to the fluorescence detection result.

The fluorescence initiation position refers to the relative position of the microscope objective and the workpiece to be processed when the fluorescence starts to appear.

Step 203: Adjust the relative position of the microscope objective and the workpiece to be processed to the fluorescence initiation position, so that the laser focus can be landed on the workpiece to be processed's surface.

Similar to the first embodiment, in the process of performing the position adjustment within the preset travel range in this embodiment, the adjustment speed is not specified. In actual operation, the user can align the optical axis of the laser beam with different irradiation areas of the workpiece to be processed's surface, and repeat steps 201 to 202 to obtain the fluorescence initiation position corresponding to each illumination area. Then these fluorescence initiation positions can be obtained. The positions are averaged to confirm the most ideal landing position, and the inclination angle of the workpiece to be processed's surface relative to the microscope objective can also be calculated and corrected based on these fluorescence initiation positions.

To sum up, this embodiment utilizes the characteristics that the dielectric layer doesn't generate fluorescence. The workpiece to be processed can generate fluorescence when the laser is focused inside it. The fluorescence initiation position is identified by detecting the switch of the fluorescence, thereby realizing the landing of the laser focus. This embodiment is suitable for workpiece to be processeds generating fluorescence for quick and accurate surface adjustment.

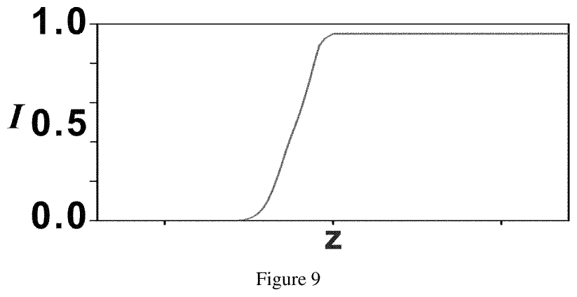

FIG. 8 shows a graph of the results of a scan based on the method of scanning reflected light intensity. FIG. 9 shows a graph of the results based on the fluorescence scan method. The horizontal axis in the figure is the spatial coordinate along the optical axis, and the vertical axis is the normalized light intensity. These two methods do not require the absolute value of the laser light intensity, and the normalized light intensity is used to calculate its spatial coordinate position. In addition, since most of the workpiece to be processeds can generate fluorescence, which are suitable for three-dimensional processing. In this case, the laser focus can penetrate deep into the workpiece to be processed. Therefore, the accuracy of 100 nanometers can meet the requirements.

### Embodiment 3

This embodiment provides an automatic landing system, including: a microscope objective, an image sensor, a driver, a detector, and a controller.

The microscope objective is used to focus the laser beam at the desired position and used for microscopic imaging;

The image sensor is used to take real-time images of the workpiece to be processed during the position adjustment process. The image sensor may be a CCD camera or use other devices with image or video acquisition functions, which are not limited in specificity.

The detector is used to detect the intensity of reflected light in real-time according to the image.

The controller is used to adjust the relative position of the microscope objective and the workpiece to be processed through driving the objective along the optical axis direction within the preset travel range. It is also used to determine the position of the strongest reflected light according to the detection data of the detector. The position of the strongest light reflection is the relative position of the microscope objective and the workpiece to be processed when the intensity of the reflected light reaches the maximum value.

In addition, the controller can also be used to obtain multiple positions of the strongest reflected light when the laser beam is focus to different designated areas of the workpiece to be processed's surface, and calculate the average position of microscope objective according to the multiple positions of the strongest reflected light positions. The tilt angle is calculated, and/or the average position of the positions of strongest reflected light is calculated. The relative position of the microscope objective and the workpiece to be processed is adjusted according to the average position to perform laser processing.

The automatic landing system of this embodiment identifies the position of the strongest reflected light by scanning the intensity of the reflected light to quickly and accurately adjust the laser focus to land on the surface of the workpiece to be processed. Therefore, this embodiment applies to any type of workpiece to be processed, and is especially suitable for workpiece to be processeds that have obvious reflection, such as two-dimensional material surfaces or metal-coated surfaces.

In addition, since this embodiment is mainly implemented by software, the hardware only needs to be equipped with a low-cost image sensor, and no major changes are required to the existing laser processing system, so the entire solution is cost-effective.

### Embodiment 4

This embodiment provides another automatic landing system, including: a microscope objective, an image sensor, a driver, a detector, and a controller.

The microscope objective is used to focus the laser beam at the desired position and used for microscopic imaging;

The image sensor is used to take real-time images of the workpiece to be processed processed during the position adjustment process;

The detector is used for real-time detection of whether fluorescence is generated according to the image;

The controller is used to adjust the relative position of the microscope objective and the workpiece to be processed along the optical axis direction through the driver within the preset travel range. It is also used to determine the fluorescence initiation position according to the fluorescence detection result. The fluorescence initiation position is the relative position of the microscope objective and the workpiece to be processed when the fluorescence starts to appear.

In addition, the controller is also used to obtain a plurality of fluorescence initiation positions when the laser beam is focused to different designated areas of the workpiece to be processed's surface, and calculate the inclination angle of the workpiece to be processed's surface relative to the microscope objective according to the multiple fluorescence initiation positions, and/or, is also used to calculate the average position of multiple fluorescence initiation positions, and adjust the relative position of the microscope objective and the workpiece to be processed according to the average position to perform laser processing.

The automatic landing system of this embodiment identifies the fluorescence initiation position by scanning the fluorescence, thereby realizing the purpose of quickly and accurately adjusting the laser focus to land on the workpiece to be processed's surface. Therefore, this embodiment is suitable for the workpiece to be processeds that can generate fluorescence.

### Embodiment 4

This embodiment provides another automatic landing system, including: a microscope objective, an image sensor, a driver, a detector, and a controller.

The microscope objective is used to focus the laser beam at the desired position and used for microscopic imaging;

The image sensor is used to take real-time images of the workpiece to be processed during the position adjustment process;

The detector is used for real-time detection of whether fluorescence is generated according to the image;

The controller is used to adjust the relative position of the microscope objective and the workpiece to be processed along the optical axis direction through the driver within the preset travel range. It is also used to determine the fluorescence initiation position according to the fluorescence detection result. The fluorescence initiation position is the relative position of the microscope objective and the workpiece to be processed when the fluorescence starts to appear.

In addition, the controller is also used to obtain a plurality of fluorescence originating positions when the laser beam is focused to different designated areas of the workpiece to be processed's surface and calculate the inclination angle of the workpiece to be processed's surface relative to the microscope objective according to the multiple fluorescence initiation positions, and/or, is also used to calculate the average position of multiple fluorescence initiation positions, and adjust the relative position of the microscope objective and the workpiece to be processed according to the average position to perform laser processing.

The automatic landing system of this embodiment identifies the fluorescence initiation position by scanning the fluorescence, thereby realizing the purpose of quickly and accurately adjusting the laser focus to land on the workpiece to be processed's surface. Therefore, this embodiment is suitable for the workpiece to be processed that can generate fluorescence.

### Embodiment 5

Those of ordinary skill in the field can understand that instructions can complete all or part of the steps in the above-mentioned automatic landing method or completed by instructions to control relevant hardware. The instructions can be stored in a computer-readable storage medium and loaded and executed by processors.

To this end, an embodiment of the present invention further provides a storage medium, which stores a plurality of instructions. A processor can load the instructions to execute the steps in the automatic landing method provided by the embodiment of the present invention.

Wherein the storage medium may include: a read-only memory (ROM, Read Only Memory), a random access memory (RAM, Random Access Memory), a hard disk or an optical disk, and the like.

As mentioned above, the above embodiments are only used to illustrate the technical solutions of the present invention but not to limit them. Although the present invention has been described in detail with reference to the above embodiments, those of ordinary skill in the field should understand: The technical solutions described in the embodiments are modified, or some technical features thereof are equivalently replaced; and these modifications or replacements do not make the essence of the corresponding technical solutions depart from the spirit and scope of the technical solutions of the embodiments of the present invention.

1. An automatic landing method for laser processing, characterized in that it comprises:
within the preset travel range, adjust the relative position of the microscope objective and the workpiece to be processed along the direction of the optical axis; during the adjustment process, the image of the workpiece to be processed is collected in real-time, and the intensity of the reflected light is detected in real-time according to the image;
according to the intensity detection data of the reflected light, determine the position of the strongest reflected light; the position of the strongest reflected light, that is, the relative position of the microscope objective and the workpiece to be processed when it is detected that the intensity of the reflected light reaches the maximum value.

2. The automatic landing method according to claim 1, wherein the automatic landing method further comprises:
obtaining a plurality of positions of the strongest reflected light; each position of the strongest reflected light is determined when the laser beam is focused on different designated areas of the surface to be processed;
according to the multiple positions of the strongest reflected light, the inclination angle of the surface to be processed relative to the microscope objective is calculated.

3. The automatic landing method according to claim 1, wherein the automatic landing method further comprises:
obtaining a plurality of positions of the strongest reflected light; each position of the strongest reflected light is determined when the laser beam is focused on different designated areas of the surface to be processed;
calculating the average position of the multiple positions of the strongest reflected light;
according to the average position, after adjusting the relative position of the microscope objective and the workpiece to be processed, laser processing is performed.

4. The automatic landing method according to claim 1, wherein the real-time detection of the intensity of the reflected light according to the image comprises:
the grayscale value of the reflected light area in the image is calculated first, and then the grayscale value is converted and calculated to obtain the intensity of the reflected light.

5. An automatic landing method for laser processing, characterized in that it comprises:
within the preset travel range, adjust the relative position of the microscope objective and the workpiece to be processed along the direction of the optical axis; during the adjustment process, the image of the workpiece to be processed is collected in real-time, and detect whether fluorescence is generated according to the image in real-time;
according to the fluorescence detection result, determine the fluorescence initiation position; the fluorescence initiation position is the relative position of the microscope objective and the workpiece to be processed when the fluorescence starts to appear.

6. The automatic landing method according to claim 4, wherein the automatic landing method further comprises:
obtaining a plurality of fluorescence initiation positions; each fluorescence initiation position is determined when the laser beam is focused on different designated areas of the surface to be processed;
according to the plurality of fluorescence originating positions, the inclination angle of the surface to be processed relative to the microscope objective is calculated.

7. The automatic landing method according to claim 5, wherein the automatic landing method further comprises:
obtaining a plurality of fluorescence initiation positions; each fluorescence initiation position is determined when the laser beam is focused on different designated areas of the surface to be processed;
calculating the average position of the multiple fluorescence initiation positions;
according to the average position, after adjusting the relative position of the microscope objective and the workpiece to be processed, laser processing is performed.

8. An automatic landing system for laser processing, comprising a microscope objective for focusing a laser beam; it is characterized in that it further comprises: an image sensor, a driver, a detector, and a controller;
the image sensor is used to capture the image of the workpiece to be processed in real-time during the position adjustment process;
the detector, configured to detect the intensity of the reflected light in real-time according to the image;
the controller is used to adjust the relative position of the microscope objective and the workpiece to be processed through the driver within a preset travel range along the optical axis direction; and is also used to determine according to the detection data of the detector, the position of the strongest reflected light; the position of the strongest reflected light, that is, the relative position of the microscope objective and the workpiece to be processed when it is detected that the intensity of the reflected light reaches the maximum value.

9. The automatic landing system according to claim 8, wherein the controller is further configured to obtain a plurality of positions of the strongest reflected light; each position of the strongest reflected light is determined by focusing laser beam on designated areas of the surface to be processed; the inclination angle of the surface to be processed relative to the microscope objective is calculated according to the multiple positions of the strongest reflected light, and/or, the multiple positions of the strongest reflected light are used to calculate the average position; according to the average position, after adjusting the relative position of the microscope objective and the workpiece to be processed, laser processing is performed.

10. An automatic landing system for laser processing, comprising a microscope objective for focusing a laser beam; it is characterized in that it further comprises: an image sensor, a driver, a detector, and a controller;
the image sensor is used to capture the image of the workpiece to be processed in real-time during the position adjustment process;
the detector is used for detecting in real-time whether fluorescence is generated according to the image;
the controller is used to adjust the relative position of the microscope objective and the workpiece to be processed through the driver within a preset travel range along the optical axis direction; and is also used to determine the fluorescence initiation position according to the fluorescence detection result; the fluorescence initiation position is the relative position of the microscope objective and the workpiece to be processed when the fluorescence starts to appear.

11. The automatic landing system according to claim 10, wherein the controller is further configured to obtain a plurality of fluorescence initiation positions, and each fluorescence initiation position is determined by focusing the laser beam on different areas of the surface to be processed; the inclination angle of the surface to be processed relative to the microscope objective is calculated according to the multiple fluorescence initiation positions, and/or, the multiple fluorescence initiation positions are used to calculate the average position; according to the average position, after adjusting the relative position of the microscope objective and the workpiece to be processed, laser processing is performed.

12. A storage medium, characterized in that the storage medium stores a plurality of instructions, and the instructions are adapted to be loaded by a processor to execute the steps in the automatic landing method according to any one of claims 1 to 7.
